(19) United States
(12) Patent Application Publication
(10) Pub. No.: US 2009/0228779 A1
(43) Pub. Date: Sep. 10, 2009

(54) USE OF REMOTE SERVICES BY A LOCAL WIRELESS ELECTRONIC DEVICE

(76) Inventors: Richard John Williamson, Los Gatos, CA (US); Darin Adler, Los Gatos, CA (US); Aaron Eliezer Golden, Santa Clara, CA (US); Christopher Blumenberg, San Fransisco, CA (US); Maciej Stachowiak, San Fransisco, CA (US); Anders Carlsson, Cupertino, CA (US); Alexey Proskuryakov, Moscow (RU)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/397,617

(22) Filed: Mar. 4, 2009

Related U.S. Application Data
(60) Provisional application No. 61/033,767, filed on Mar. 4, 2008.

(51) Int. Cl. G06F 3/01; G06F 9/46; G06F 17/30; G06F 3/048; G06F 17/00

(52) U.S. Cl. 715/233; 719/328; 715/733; 707/200; 715/835; 715/234; 715/205; 715/781; 707/10

(57) ABSTRACT

The present disclosure generally relates to enabling web applications to use application programming interfaces (APIs) to display content on a mobile computing device. In some embodiments, the APIs can include services to enable web applications to simulate a native application that runs natively on the mobile computing device. In some embodiments, the APIs can include services to annotate a map with an overlay on the display of the mobile computing device. In some embodiments, a caching module is provided for caching resources associated with a web application on the mobile computing device.

The present application claims priority to U.S. Provisional Application No. 61/033,767, filed Mar. 4, 2008, and entitled APPLICATION PROGRAMMING INTERFACES FOR DISPLAYING WEB APPLICATIONS ON A MOBILE COMPUTING DEVICE.

### BACKGROUND

1. Field

This disclosure generally relates to the field of application programming interfaces. More specifically, this disclosure relates to computer-implemented methods and systems for enabling web applications to display content on a mobile computing device.

2. Description of the Related Technology

Some mobile computing devices offer web browsers to render content associated with web applications. Such web browsers can be important because they can render web pages that include HTML, CSS, JavaScript, or XML.

A significant problem with web browsers is that they make web applications appear different than native applications and provide a different look and feel. These issues are especially problematic when a mobile computing device is offline and a web application cannot run on the mobile computing device. However, native applications, such as Java-based applications are plagued by instability and security vulnerabilities in the mobile computing device environment.

Accordingly, it would be desirable to provide APIs in a mobile computing device that allows web applications accessed over a network to emulate or simulate a native application that runs natively on a mobile computing device.

### BRIEF DESCRIPTION OF THE DRAWINGS

FIG. 1A illustrates a system configured to enable a web application to place content on a display of a mobile computing device, in accordance with some embodiments of the inventions.

FIG. 1B is a block diagram of a mobile computing device shown in FIG. 1A.

FIG. 2 illustrates the application programming interface of FIG. 1 and various interfaces that can be provided to the web application, in accordance with some embodiments of the inventions.

FIG. 3 illustrates the caching module of FIG. 1, whereby the caching module is configured to create an offline manifest of the web application.

FIG. 4 is a flow chart illustrating embodiments of exemplary methods for providing the web application with a similar look and feel as a native application on the display of the mobile computing device.

FIG. 5 is a flow chart illustrating embodiments of exemplary methods for creating an offline manifest of the web application on the mobile computing device.

FIG. 6 is a flow chart illustrating embodiments of exemplary methods for handling a service request received from the web application to interact with a map on the display of the mobile computing device.

FIGS. 7A and 7B illustrate example windows that can be displayed on the mobile computing device when the web application is run.

FIG. 8A illustrates an example embodiment of a mobile device.

FIG. 8B illustrates an example embodiment of a configurable top-level graphical user interface of a mobile device.

FIG. 9 is a block diagram of an example implementation of a mobile device.

### DETAILED DESCRIPTION

The present disclosure generally relates to enabling web applications to use application programming interfaces (APIs) to display content on a mobile computing device. In some embodiments, the APIs can include services to enable web applications to simulate a native application that runs natively on the mobile computing device. In some embodiments, the APIs can include services to annotate a map with an overlay on the display of the mobile computing device. In some embodiments, a caching module is provided for caching resources associated with a web application on the mobile computing device. In some embodiments, the mobile computing device can include an Apple iPhone™.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

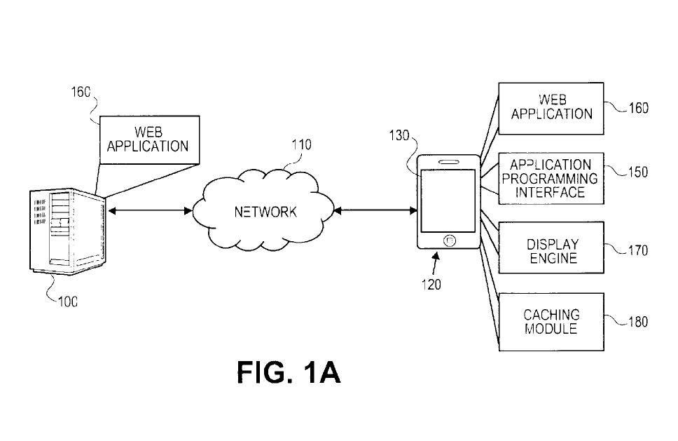

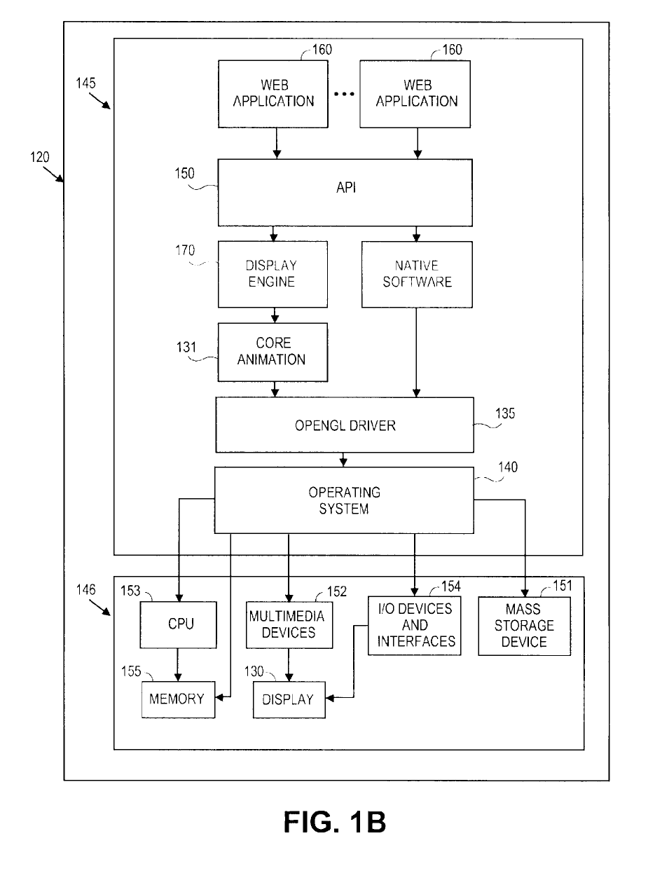

FIG. 1A illustrates a system configured to enable web application 160 to place content on display 130 of mobile computing device 120, in accordance with some embodiments of the inventions. In the illustrated embodiment, a server system 100 is in communication with network 110, and/or mobile computing device 120 is also in communication with network 110. Communication over the network can take place using sockets, ports, and/or other mechanisms recognized in the art. Mobile computing device 120 includes display 130 to place content, such as animation, for viewing by a user of the device.

Server system 100 can include one or more multiple physical computers/machines and/or associated content that are accessible via network 110. Server system 100 can be implemented using physical computer servers that are geographically remote from one another and/or may include content that spans multiple internet domains. As shown in the illustrated embodiment, server system 100 can be accessible by mobile computing device 120 via network 110. In the illustrated embodiments, server system 100 hosts web application 160 that can provide functionality for users of mobile computing device 120. Web application 160 can include HTML, JavaScript, XML, PHP, CSS, Flash, Java, and/or the like. In some embodiments, web application 160 can include AJAX applications and/or Web 2.0 applications. The web application can be accessed over network 110 and display its content based on a markup language file, which can include, for example, a HTML file.

In some embodiments, server system 100 can include a web server (not shown) that provides users of mobile computing device 120 access to web application 160. The web server may be implemented as one or more physical servers/machines that execute web server software. The web server can access a HTML database (not shown) and various back-end components that are used to generate web pages of web application 160 in response to the actions of end users on mobile computing device 120. As depicted in FIG. 1, server system 100 can send and/or mobile computing device 120 can be configured to receive the web pages and/or web application 160 over network 110 to run on mobile computing device 120.

Mobile computing device 120 can include a cell phone, smart phone, personal digital assistant, audio player, and/or the like. In some embodiments, mobile computing device 120 can include an Apple iPhone™. Mobile computing device 120 can further include one or more application programming interfaces (APIs) 150 that can enable web application 160 to display content on mobile computing device 120.

In some embodiments, application programming interface 150 can be configured to enable web application 160 to appear like a native application and/or provide a similar look and/or feel as a native application on display 130 of mobile computing device 120. Application programming interface 150 can also be configured to support requests for services made from web application 160 to run in a full screen mode on display 130 of mobile computing device 120. In some embodiments, application programming interface 150 can also be configured to support requests for services made from web application 160 to annotate a map on display 130 of mobile computing device 120.

Mobile computing device 120 can include display engine 170. Display engine 170 can be configured to display web application 160 in the full screen mode such that web application 160 appears like a native application and/or provides a similar and/or same look and/or feel. In some embodiments, application programming interface 150 can be configured to execute display engine 170 in response to a service request from web application 160 to appear like a native application on display 130 of mobile computing device 120. In some embodiments, display engine 170 can include the WebKit browser engine and/or be a web browser. Display engine 170 can display web application 160 in a form that emulates and/or simulates a native application that can be accessed natively on the system.

In some embodiments, mobile computing device 120 can also include caching module 180. Caching module 180 can be configured to create an offline manifest of web application 160 on mobile computing device 120. In some embodiments, the updating of the offline manifest of web application 160 can be driven by web application 160. In some embodiments, the updating of the offline manifest of web application 160 can be based on user behavior and/or history.

The functionality provided for in the components, applications, application programming interfaces, interfaces, engines, and/or modules described herein can be combined and/or further separated. In general, the words “module,” “interface,” “application programming interface,” “engine,” and/or “application” as used herein, refers to logic embodied in hardware or firmware, or to a collection of software instructions, possibly having entry and exit points, written in a programming language, such as, for example, Java, JavaScript HTML, Objective-C, Lua, C, and/or C++. A software module, interface, application programming interface, engine, and/or application may be compiled and linked into an executable program, installed in a dynamic link library, or may be written in an interpreted programming language such as, for example, BASIC, Perl, or Python. It will be appreciated that software modules, interfaces, application programming interfaces, engines, and/or applications may be callable from other modules, interfaces, application programming interfaces, engines, and/or applications, or from themselves, and/or may be invoked in response to detected events or interrupts. Software instructions may be embedded in firmware, such as an EPROM. It will be further appreciated that hardware modules, interfaces, application programming interfaces, engines, and/or applications may include connected logic units, such as gates and flip-flops, and/or may include programmable units, such as programmable gate arrays or processors. The modules, interfaces, application programming interfaces, engines, and/or applications described herein are preferably implemented as software modules, interfaces, application programming interfaces, engines, and/or applications, but may be represented in hardware or firmware. Generally, the modules, interfaces, engines, application programming interfaces, and/or applications described herein refer to logical modules, interfaces, application programming interfaces, engines and/or applications that may be combined with other modules, interfaces, application programming interfaces, engines, and/or applications or divided into sub-modules, sub-interfaces, sub-engines, sub-application programming interfaces, and/or sub-applications despite their physical organization or storage.

FIG. 1B illustrates mobile computing device 120 at software level 145 and hardware level 146. At software level 145, web application 160 may utilize application programming interface (API) 150 to request services from display engine 170. Display engine 170 can then display the web application in a form that emulates and/or simulates a native application accessed natively on mobile computing device 120. In some embodiments, display engine 170 can access Core Animation software 131, or OpenGL driver 135 to display content on display 130.

In block 131, Core Animation software 131 may help render certain aspects, such as animations, of the document content and document presentation. Core Animation software 131 is a data visualization software used by Apple's Mac OS X 10.5 to produce animated user interfaces. Core Animation software 131 provides a way for third party developers to produce animated user interfaces via an implicit animation model.

In block 135, Open Graphics driver (OpenGL) 135 may be used by the Core Animation software 131 to help render any animations in web application 160 that can be accessed over a network and be based on a HTML file. OpenGL is a standard specification defining a cross-language cross-platform API for writing applications that produce 2D and 3D computer graphics. OpenGL can be used to draw complex three-dimensional scenes from simple primitive shapes or models. It may be appreciated that other hardware or software acceleration may be used to help render any animations in web application 160.

Operating system (OS) layer 140 may control mobile computing device 120. Operating system layer 140 may include Mac OS X, OS X, Linux, Windows, or any number of proprietary operating systems. Conventional operating systems control and schedule computer processes for execution, perform memory management, provide file system, networking, and I/O services, and provide a user interface, such as a graphical user interface (GUI), among other things.

On hardware level 146, mobile computing device 120 includes memory 155, such as random access memory (RAM) for temporary storage of information and a read only memory (ROM) for permanent storage of information, and mass storage device 151, such as a hard drive, diskette, or optical media storage device. Mass storage device 151 may include one or more hard disk drives, optical drives, networked drives, or some combination of various digital storage systems. Mobile computing device 120 also includes central processing unit (CPU) 153 for computation. Typically, the modules of the computing device 120 are in data communication via one or more standards-based bus systems. In different embodiments, the standards based bus system could be Peripheral Component Interconnect (PCI), Microchannel, SCSI, Industrial Standard Architecture (ISA) and Extended ISA (EISA) architectures, for example.

The exemplary mobile computing device 120 may include one or more of commonly available input/output (I/O) devices and interfaces 154, such as a touchpad, or keypad. In one embodiment, I/O devices and interfaces 154 include display 130 that allows the visual presentation of data to a user. More particularly, display devices provide for the presentation of GUIs, application software data, and multimedia presentations, for example. In one embodiment, a GUI includes one or more display panes in which images may be displayed. Mobile computing device 120 may also include one or more multimedia devices 152, such as speakers, video cards, graphics accelerators, and microphones. Multimedia devices 152 can include a graphics processing unit. Exemplary mobile computing devices 120 may include devices, such as Apple's iPhone™ and iPod™ touch devices.

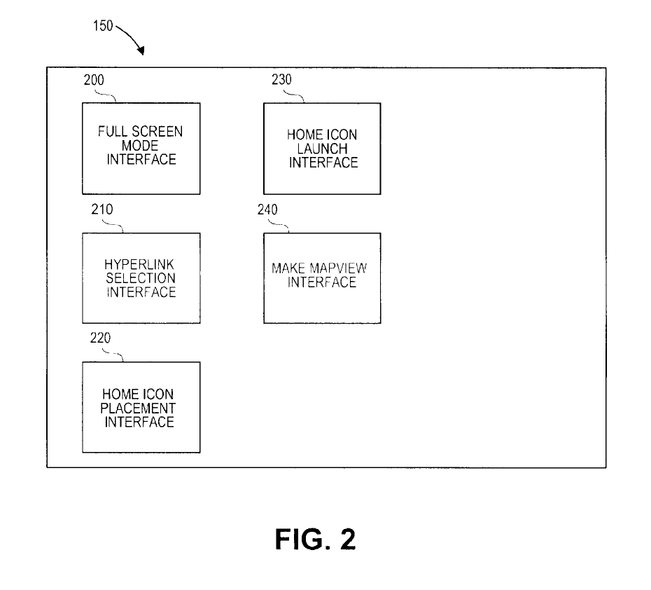

FIG. 2 illustrates application programming interface 150 of FIG. 1 and various interfaces that can be provided to web application 160, in accordance with some embodiments of the inventions. In some embodiments, application programming interface 150 can include one or more interfaces configured to enable a service request from web application 160 to run in full screen mode on display 130 of mobile computing device 120. The interfaces illustrated can, in some embodiments, be divided or combined with other interfaces and/or be included in one or more separate application programming interfaces 150.

Application programming interface 150 can include full screen mode interface 200. Full screen mode interface 200 can be configured to support requests for services made from web application 160 to run in a full screen mode on display 130 of mobile computing device 120. In some embodiments, full screen mode interface 200 can include a HTML meta element. The HTML meta element can include one or more properties and/or one or more values. The one or more properties can be configured to enable the service request from web application 160 to run in the full screen mode. In some embodiments, the HTML meta element can be used to specify that web application 160 is capable of being run in the full screen mode. Display engine 170 can be configured to process the HTML meta element and display web application 160 in full screen mode depending on the setting of the HTML meta element. In some embodiments, various tags and/or attributes of the HTML meta element and/or other HTML elements can be used to enable the full screen mode.

In various embodiments, the full screen mode can include displaying web application 160 in a window that occupies the entire display 130 of mobile computing device 120. The full screen mode can also include not displaying the web browser chrome in the window. The web browser chrome can include the borders of a web browser window, which can include the window frames, menus, toolbars and/or scroll bars. In some embodiments, web application 160 may not launch in a web browser application window. Advantageously, the full screen mode can minimize scrolling in the window. In some embodiments, the full screen mode can include not displaying a toolbar in the window. The web browser can include any web browser application, such as Mozilla Firefox, Apple Safari, and/or Microsoft Internet Explorer, which implement the basic World Wide Web standards such as HTTP and HTML.

In some embodiments, web application 160 can send a service request to full screen mode interface 200 to run in the full screen mode on mobile computing device 120. The service request can include sending as the input to full screen mode interface 200 a HTML meta element and/or one or more strings with an attribute identifying a property name and/or an attribute specifying a property value. Full screen mode interface 200 can be configured to execute display engine 170 in response to the service request. Display engine 170 can be configured to enable the service request from web application 160 to display web application 160 in the full screen mode such that web application 160 is provided a similar look and/or feel as the native application on display 130 of mobile computing device 120. The full screen mode can display the web application in a window on display 130 of mobile computing device 120 so that it appears like a native application.

In some embodiments, the HTML meta element and/or one or more properties and/or one or more values can be configured to enable web application 160 to appear in the window in a portrait orientation and/or landscape orientation. In some embodiments, the HTML meta element and/or one or more properties and/or one or more values can be configured to enable web application 160 to adjust a size of the window. In some embodiments, the HTML meta element and/or one or more properties and/or one or more values can be configured to enable web application 160 to enable and/or disable scrolling in the window. In some embodiments, the HTML meta element and/or one or more properties and/or one or more values can be used to specify a window size. In some embodiments, the HTML meta element and/or one or more properties and/or one or more values can be configured to enable web application 160 to enable scaling in the window. In some embodiments, various tags and/or attributes of the HTML meta element and/or other HTML elements can be used to configure the foregoing.

Application programming interface 150 can, in some embodiments, include hyperlink selection interface 210. In some embodiments, web application 160 can include a hyperlink URL to a second web application. Hyperlink selection interface 210 can be configured to determine whether the second web application is configured to run in the full screen mode. In some embodiments, hyperlink selection interface 210 can be configured to enable or disable the second web application from running in the full screen mode in response to the selection of the hyperlink URL. In some embodiments, hyperlink selection interface 210 can be configured to use full screen mode interface 200 to determine whether the second web application can run in the full screen mode. For example, the second web application can use the HTML meta element to specify whether the second web application can be run in full screen mode. Hyperlink selection interface 210 can then use and/or call full screen mode interface to 200 to launch the second web application.

Advantageously, hyperlink selection interface 210 can be useful for resolving navigation issues related to the full screen mode that can arise, in some embodiments, when the web browser chrome is removed. For example, in some embodiments, when web application 160 is in full screen mode a user of mobile computing device 120 can select a hyperlink URL to a second web application in the window on display 130. Hyperlink selection interface 210 can then determine whether the second web application can be launched in a web browser application window and/or a window in full screen mode.

In some embodiments, application programming interface 150 can include home icon placement interface 220. Home icon placement interface 220 can be configured to enable web application 160 to place a home icon associated with web application 160 on a home screen on display 130 of mobile computing device 120. In some embodiments, the home icon can be configured to display web application 160 in the full screen mode.

Home icon placement interface 220 can be useful for adding web application 160 capable of running in full screen mode to the home screen. Further, home icon placement interface 220 enables web application 160 to appear like a native application on the home screen. Advantageously, this can allow web application 160 to have the same look and/or feel as a native application, without being developed and/or compiled for the mobile computing device 120.

Application programming interface 150 can also include home icon launch interface 230. Home icon launch interface 230 can be configured to enable the service request made from web application 160 to run in the full screen mode in response to a selection of the home icon. In some embodiments, home icon launch interface 230 can be called and/or executed after the home icon on the home screen on display 130 of mobile computing device 120 is selected. Home icon launch interface 230 can, in some embodiments, send a service request to full screen mode interface 200 to display web application 160 in full screen mode.

In some embodiments, application programming interface 150 can include make mapview interface 240. Make mapview interface 240 can be configured to support requests for services made from web application 160 to annotate a map on display 130 of mobile computing device 120. Make mapview interface 240 can be configured to enable web application 160 to interact with the map and/or annotate the map with an overlay.

The overlay can include a pin, icon, and/or a button. For example, web application 160 can send a request to make mapview interface 240 to place a restaurant icon on the map. In some embodiments, make mapview interface 240 can then annotate the map by placing the restaurant icon on the map in response to the request. In some embodiments, a make mapview object can be instantiated and/or a map loaded into the make mapview object. Web application 160 can then use the make mapview object to manipulate the loaded map.

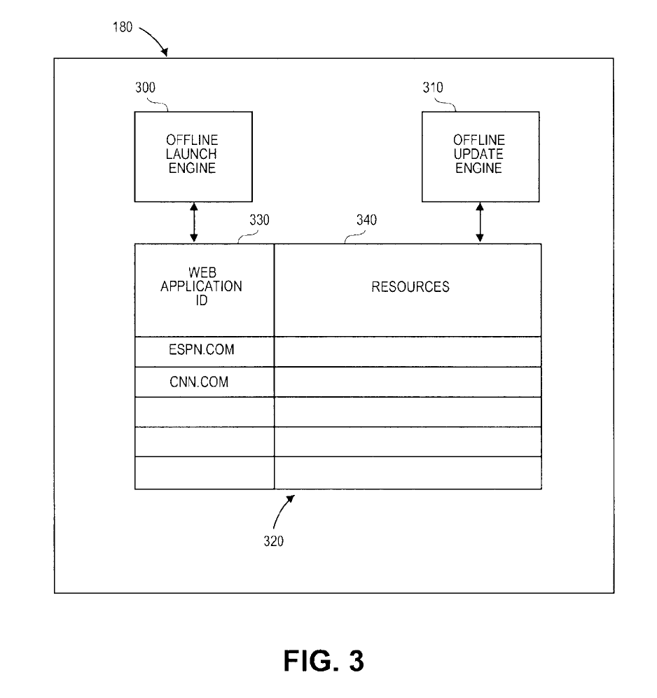

FIG. 3 illustrates caching module 180 of FIG. 1, whereby caching module 180 is configured to create an offline manifest of web application 160 on mobile computing device 120. As depicted in FIG. 3, caching module 180 can include offline manifest database 320. In the embodiments shown, each entry in offline manifest database 320 includes the following fields: web application id 330 and/or set of cached resources 340 associated with web application id 330. Offline manifest database 320 can include at least one entry with set of cached resources 340 associated with web application 160 that can be represented by web application id 330. Set of cached resources 340 can include various web application content, such as HTML, images, video, JavaScript, CSS, Java, XML, Flash, PHP, and/or the like.

The information shown in offline manifest database 320 is just one of many examples of data that may be stored for creating an offline manifest of web application 160. For example, in the illustrated embodiments, offline manifest database 320 can store web application id 330 of “cnn.com” and cache a set of resources associated with “cnn.com” as set of cached resources 340. Alternatively, caching module 180 may only store web application id 330 and/or some other subset or set of fields in offline manifest database 320.

Caching module 180 can include offline update engine 310. Offline update engine 310 can be configured to automatically check the age of set of cached resources 340 associated with web application id 330. In some embodiments, when set of cached resources 340 associated with web application id 330 is invalid offline update engine 310 can be configured to automatically update offline manifest database 320. In some embodiments, offline update engine 310 can be configured to automatically update offline manifest database 320 based on user behavior, user history, and/or other criteria when mobile computing device 120 is online. In some embodiments, offline update engine 310 can be system-driven and/or driven by web application 160.

In some embodiments, caching module 180 can also include offline launch engine 300. Offline launch engine 300 can be configured to query offline manifest database 320 for at least one entry associated with web application 160. In some embodiments, offline launch engine 300 can be configured to run in response to the selection of a home icon associated with web application 160. The home icon can be on a home screen on display 130 of mobile computing device 120. In some embodiments, offline launch engine 300 can be configured to enable and/or disable web application 160 from running in the full screen mode. Caching module 180 can use full screen mode interface 200 and/or display engine 170 to launch web application 160 in a window.

Advantageously, caching module 180, offline update engine 310, offline launch engine 300, and/or offline manifest database 320 can enable web application 160 to run when mobile computing device 120 is offline. In some embodiments, caching module 180, home icon launch interface 230, home icon placement interface 220, and/or full screen mode interface 200 can present a user of web application 160 on mobile computing device 120 with a very similar experience as a native application.

For example, in some embodiments the home icon placement interface 230 can place a home icon for web application 160 on the home screen of mobile computing device 120. Web application 160 can use the HTML meta element and/or full screen mode interface 200 to launch in full screen mode. Offline update engine 310 of caching module 180 can then ensure the cached resources associated with web application 160 are valid by checking offline manifest database 320 when mobile computing device 120 is online. Home icon launch interface 230 can then be used to launch web application 160 in response to the selection of the home icon associated with web application 160 on the home screen. Offline launch engine 300 can be used to gather the cached resources associated with web application 160. Display engine 170 and/or full screen mode interface 200 can then be used to display web application 160 in a window in the full screen mode.

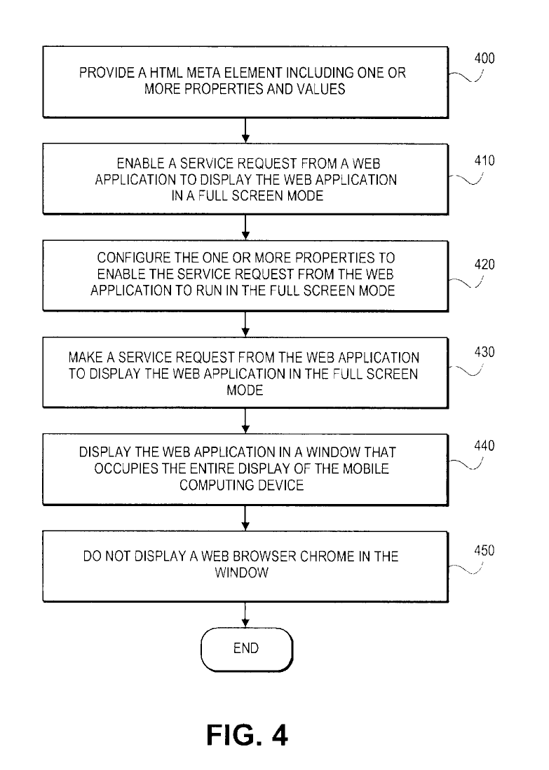

FIG. 4 is a flow chart illustrating embodiments of exemplary methods for providing web application 160 with a similar look and/or feel as a native application on display 130 of mobile computing device 120. In exemplary embodiments, this process can be executed when web application 160 is developed for mobile computing device 120. The process can, in some embodiments, be executed when web application 160 runs on mobile computing device 120.

In step 400, a HTML meta element including one or more properties and/or one or more values is provided. In some embodiments, application programming interface 150 can be provided. Application programming interface 150 can include full screen mode interface 200. In some embodiments, full screen mode interface 200 can include the HTML meta element. The HTML meta element can include one or more properties and/or one or more values.

In step 410, a service request from web application 160 to display web application 160 in the full screen mode is enabled. Full screen mode interface 200 can be configured to support requests for services made from web application 160 to run in a full screen mode on display 130 of mobile computing device 120. In some embodiments, the HTML meta element can be used to specify that web application 160 is capable of being run in the full screen mode. The service request can include sending as the input to full screen mode interface 200 a HTML meta element and/or one or more strings with an attribute identifying a property name and/or an attribute specifying a property value.

In step 420, the one or more properties are configured to enable the service request from web application 160 to run in the full screen mode. The one or more properties of the HTML meta element can be configured to enable the service request from web application 160 to run in the full screen mode. In some embodiments, various tags and/or attributes of the HTML meta element and/or other HTML elements can be used to enable the full screen mode.

In step 430, web application 160 makes a service request to display web application 160 in full screen mode. In some embodiments, web application 160 can send a service request to full screen mode interface 200 to run in the full screen mode on mobile computing device 120. The service request can include sending as the input to the full screen mode interface a HTML meta element and/or one or more strings with an attribute identifying a property name and/or an attribute specifying a property value.

In step 440, web application 160 is displayed in a window that occupies the entire display 130 of mobile computing device 120. Full screen mode interface 200 can be configured to execute display engine 170 in response to the service request. Display engine 170 can be configured to enable the service request from web application 160 to display web application 160 in the full screen mode such that web application 160 is provided a similar look and/or feel as the native application on display 130 of mobile computing device 120. The full screen mode can display web application 160 in a window on display 130 of mobile computing device 120 so that it appears like a native application. In various embodiments, the full screen mode can include displaying web application 160 in a window that occupies the entire display 130 of mobile computing device 120.

In step 450, the web browser chrome is not displayed in the window. In some embodiments, the full screen mode can also include not displaying the web browser chrome in the window. The web browser chrome can include the borders of a web browser window, which can include the window frames, menus, toolbars and/or scroll bars.

In some embodiments, web application 160 may not launch in a web browser application window. Advantageously, the full screen mode can minimize scrolling in the window. In some embodiments, the full screen mode can include not displaying a toolbar in the window. The web browser can include any web browser application, such as Mozilla Firefox, Apple Safari, and/or Microsoft Internet Explorer, which implement the basic World Wide Web standards such as HTTP and HTML.

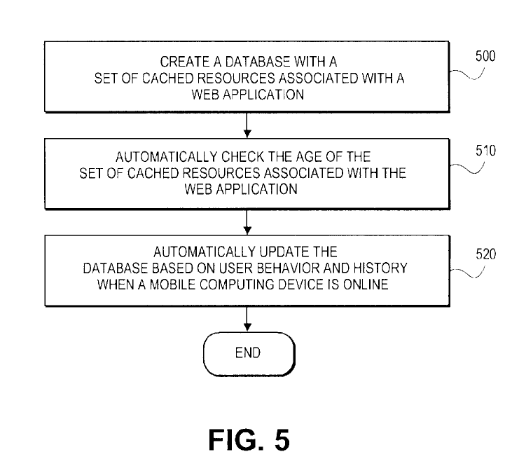

FIG. 5 is a flow chart illustrating embodiments of exemplary methods for creating an offline manifest of web application 160 on mobile computing device 120. In exemplary embodiments, this process can be executed by caching module 180. The process can, in some embodiments, be executed when a user interacts with mobile computing device 120 and/or mobile computing device 120 is online.

In step 500, offline manifest database 320 with a set of cached resources associated with web application 160 is created. Offline manifest database 320 can be configured to store one or more entries. Each entry in offline manifest database 320 can include the following fields: web application id 330 and/or set of cached resources 340 associated with web application id 330. Offline manifest database 320 can include at least one entry with set of cached resources 340 associated with web application 160 that can be represented by web application id 330. Set of cached resources 340 can include various web application content, such as HTML, images, video, JavaScript, CSS, Java, XML, Flash, PHP, and/or the like.

Offline manifest database 320 is just one of many examples of data that may be stored for creating an offline manifest of web application 160. For example, offline manifest database 320 can store web application id 330 of “cnn.com” and cache a set of resources associated with “cnn.com” as set of cached resources 340. Alternatively, caching module 180 may only store web application id 330 and/or some other subset or set of fields in offline manifest database 320.

In step 510, the age of the set of cached resources associated with the web application is automatically checked. Offline update engine 310 can be configured to automatically check the age of set of cached resources 340 associated with web application id 330. The age checking can occur when mobile computing device 120 is online.

In step 520, offline manifest database 320 is automatically updated based on user behavior and/or history when mobile computing device 120 is online. In some embodiments, when set of cached resources 340 associated with web application id 330 is invalid offline update engine 310 can be configured to automatically update offline manifest database 320. In some embodiments, offline update engine 310 can be configured to automatically update offline manifest database 320 based on user behavior, user history, and/or other criteria when mobile computing device 120 is online. In some embodiments, offline update engine 310 can be system-driven and/or driven by web application 160.

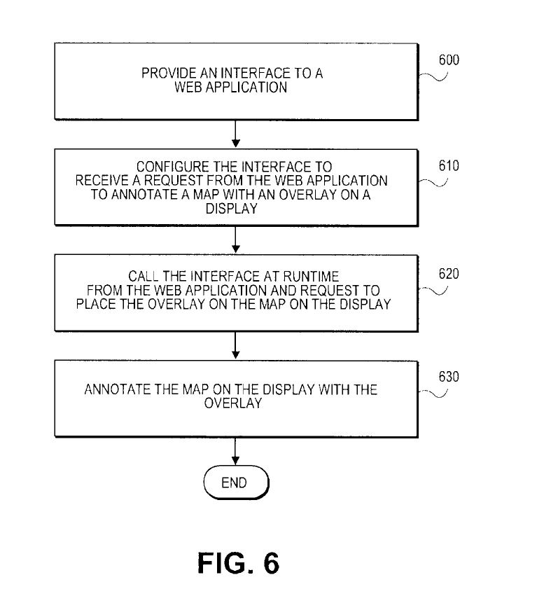

FIG. 6 is a flow chart illustrating embodiments of exemplary methods for handling a service request received from web application 160 to interact with a map on display 130 of mobile computing device 120. In exemplary embodiments, this process can be executed when web application 160 is developed for mobile computing device 120. The process can, in some embodiments, be executed when web application 160 runs on mobile computing device 120.

In step 600, an interface is provided to web application 160. In some embodiments, application programming interface 150 can be provided. Application programming interface 150 can include make mapview interface 240. Next, in step 610, the interface is configured to receive a service request from web application 160 to annotate the map with an overlay on display 130 of mobile computing device 120.

In step 620, the interface is called at runtime from web application 160 and requested to place the overlay on the map on display 130 of mobile computing device 120. In some embodiments, a make mapview object can be instantiated and/or a map loaded into the make mapview object. Web application 160 can then use the make mapview object to manipulate the loaded map.

In step 630, the map on display 130 of mobile computing device 120 is annotated with the overlay. The overlay can include a pin, icon, and/or a button. For example, web application 160 can send a request to make mapview interface 240 to place a restaurant icon on the map. In some embodiments, make mapview interface 240 can then annotate the map by placing the restaurant icon on the map in response to the request.

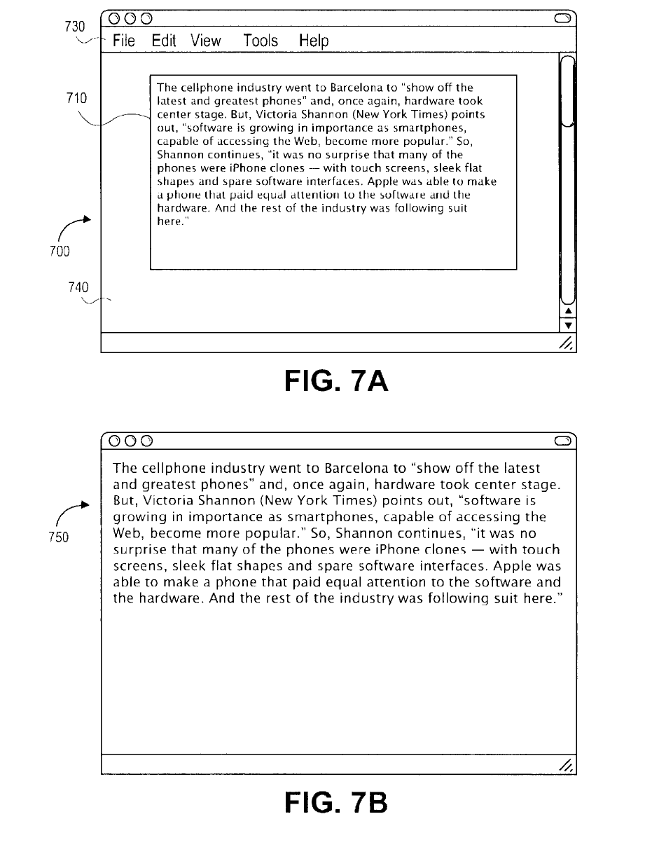

FIGS. 7A and 7B illustrate example windows that can be displayed on mobile computing device 120 when web application 160 is run. In both of the illustrated embodiments web application 160 can launch in a window on display 130 of mobile computing device 120.

As illustrated in FIG. 7A, web application 160 is launched in web browser window 700. The web browser implements the basic World Wide Web standards such as HTTP and HTML. Web browser window 700 includes toolbar 730, with various buttons, icons, and/or menus. Web browser window 700 also includes web browser chrome 740. Web browser chrome 740 includes the borders of web browser window 700, and can further include window frames, menus, toolbars and/or scroll bars. Web application 160 runs in web application area 710 that is a subset and/or a reduced amount of the area and/or space occupied by web browser window 700.

FIG. 7B illustrates web application 160 running in the full screen mode. Advantageously, full screen mode window 750 can display web application 160 in a window that occupies the entire display 130 of mobile computing device 120. In some embodiments, full screen mode window 750 can provide web application 160 with a similar look and/or feel and/or appearance as a native application. In some embodiments, full screen mode window 750 can enable the web application to not occupy a reduced amount of space and/or area, in comparison to web browser window 700 and/or web application area 710 on display 130 of mobile computing device 120. In some embodiments, full screen mode window 750 may not include web browser chrome 740. In some embodiments, full screen mode window 750 may not be web browser window 700. Advantageously, full screen mode window 750 can minimize scrolling in the window and/or not include a scrollbar. In some embodiments, full screen mode window 750 may not include toolbar 730.

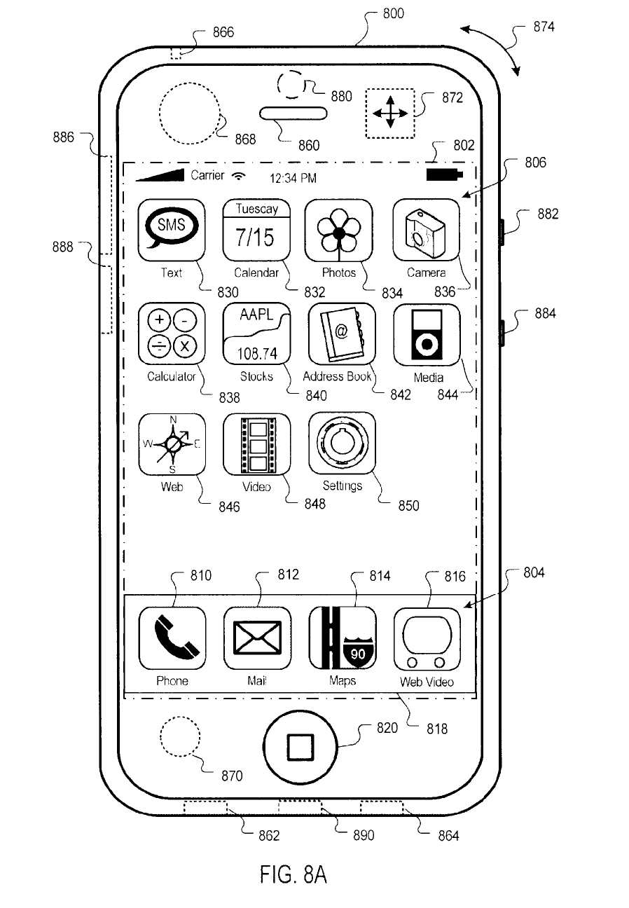

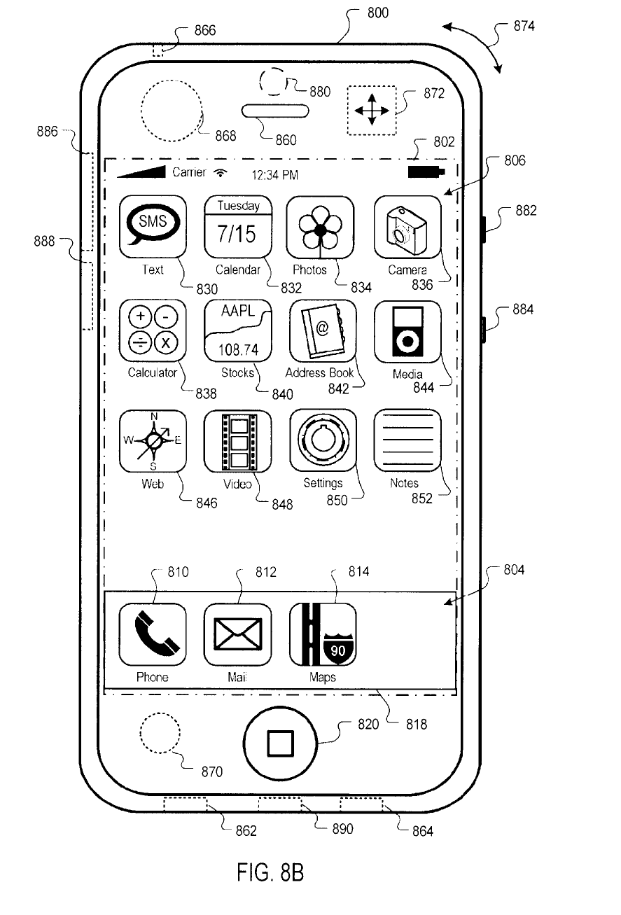

FIG. 8A illustrates an example mobile device 800. The mobile device 800 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 800 includes a touch-sensitive display 802. The touch-sensitive display 802 can be implemented with liquid crystal display (LCD) technology, light emitting polymer display (LPD) technology, or some other display technology. The touch-sensitive display 802 can be sensitive to haptic and/or tactile contact with a user.

In some implementations, the touch-sensitive display 802 can include a multi-touch-sensitive display 802. A multi-touch-sensitive display 802 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 800 can display one or more graphical user interfaces on the touch-sensitive display 802 for providing the user access to various system objects and for conveying information to the user. In some implementations, the graphical user interface can include one or more display objects 804, 806. In the example shown, the display objects 804, 806, are graphic representations of system objects. Some examples of system objects include device functions, applications, windows, files, alerts, events, or other identifiable system objects.

In some implementations, the mobile device 800 can implement multiple device functionalities, such as a telephony device, as indicated by a Phone object 810; an e-mail device, as indicated by the Mail object 812; a map devices, as indicated by the Maps object 814; a Wi-Fi base station device (not shown); and a network video transmission and display device, as indicated by the Web Video object 816. In some implementations, particular display objects 804, e.g., the Phone object 810, the Mail object 812, the Maps object 814, and the Web Video object 816, can be displayed in a menu bar 818. In some implementations, device functionalities can be accessed from a top-level graphical user interface, such as the graphical user interface illustrated in FIG. 8A. Touching one of the objects 810, 812, 814, or 816 can, for example, invoke a corresponding functionality.

In some implementations, the mobile device 800 can implement a network distribution functionality. For example, the functionality can enable the user to take the mobile device 800 and provide access to its associated network while traveling. In particular, the mobile device 800 can extend Internet access (e.g., Wi-Fi) to other wireless devices in the vicinity. For example, mobile device 800 can be configured as a base station for one or more devices. As such, mobile device 800 can grant or deny network access to other wireless devices.

In some implementations, upon invocation of a device functionality, the graphical user interface of the mobile device 800 changes, or is augmented or replaced with another user interface or user interface elements, to facilitate user access to particular functions associated with the corresponding device functionality. For example, in response to a user touching the Phone object 810, the graphical user interface of the touch-sensitive display 802 may present display objects related to various phone functions; likewise, touching of the Mail object 812 may cause the graphical user interface to present display objects related to various e-mail functions; touching the Maps object 814 may cause the graphical user interface to present display objects related to various maps functions; and touching the Web Video object 816 may cause the graphical user interface to present display objects related to various web video functions.

In some implementations, the top-level graphical user interface environment or state of FIG. 8A can be restored by pressing a button 820 located near the bottom of the mobile device 800. In some implementations, each corresponding device functionality may have corresponding “home” display objects displayed on the touch-sensitive display 802, and the graphical user interface environment of FIG. 8A can be restored by pressing the “home” display object.

In some implementations, the top-level graphical user interface can include additional display objects 806, such as a short messaging service (SMS) object 830, a Calendar object 832, a Photos object 834, a Camera object 836, a Calculator object 838, a Stocks object 840, a Address Book object 842, a Media object 844, a Web object 846, a Video object 848, a Settings object 850, and a Notes object (not shown). Touching the SMS display object 830 can, for example, invoke an SMS messaging environment and supporting functionality; likewise, each selection of a display object 832, 834, 836, 838, 840, 842, 844, 846, 848, and 850 can invoke a corresponding object environment and functionality.

Additional and/or different display objects can also be displayed in the graphical user interface of FIG. 8A. For example, if the device 800 is functioning as a base station for other devices, one or more “connection” objects may appear in the graphical user interface to indicate the connection. In some implementations, the display objects 806 can be configured by a user, e.g., a user may specify which display objects 806 are displayed, and/or may download additional applications or other software that provides other functionalities and corresponding display objects.

In some implementations, the mobile device 800 can include one or more input/output (I/O) devices and/or sensor devices. For example, a speaker 860 and a microphone 862 can be included to facilitate voice-enabled functionalities, such as phone and voice mail functions. In some implementations, an up/down button 884 for volume control of the speaker 860 and the microphone 862 can be included. The mobile device 800 can also include an on/off button 882 for a ring indicator of incoming phone calls. In some implementations, a loud speaker 864 can be included to facilitate hands-free voice functionalities, such as speaker phone functions. An audio jack 866 can also be included for use of headphones and/or a microphone.

In some implementations, a proximity sensor 868 can be included to facilitate the detection of the user positioning the mobile device 800 proximate to the user's ear and, in response, to disengage the touch-sensitive display 802 to prevent accidental function invocations. In some implementations, the touch-sensitive display 802 can be turned off to conserve additional power when the mobile device 800 is proximate to the user's ear.

Other sensors can also be used. For example, in some implementations, an ambient light sensor 870 can be utilized to facilitate adjusting the brightness of the touch-sensitive display 802. In some implementations, an accelerometer 872 can be utilized to detect movement of the mobile device 800, as indicated by the directional arrow 874. Accordingly, display objects and/or media can be presented according to a detected orientation, e.g., portrait or landscape. In some implementations, the mobile device 800 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 800 or provided as a separate device that can be coupled to the mobile device 800 through an interface (e.g., port device 890) to provide access to location-based services.

In some implementations, a port device 890, e.g., a Universal Serial Bus (USB) port, or a docking port, or some other wired port connection, can be included. The port device 890 can, for example, be utilized to establish a wired connection to other computing devices, such as other communication devices 800, network access devices, a personal computer, a printer, a display screen, or other processing devices capable of receiving and/or transmitting data. In some implementations, the port device 890 allows the mobile device 800 to synchronize with a host device using one or more protocols, such as, for example, the TCP/IP, HTTP, UDP and any other known protocol.

The mobile device 800 can also include a camera lens and sensor 880. In some implementations, the camera lens and sensor 880 can be located on the back surface of the mobile device 800. The camera can capture still images and/or video.

The mobile device 800 can also include one or more wireless communication subsystems, such as an 802.11b/g communication device 886, and/or a Bluetooth™ communication device 888. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 8B illustrates another example of configurable top-level graphical user interface of device 800. The device 800 can be configured to display a different set of display objects.

In some implementations, each of one or more system objects of device 800 has a set of system object attributes associated with it; and one of the attributes determines whether a display object for the system object will be rendered in the top-level graphical user interface. This attribute can be set by the system automatically, or by a user through certain programs or system functionalities as described below. FIG. 8B shows an example of how the Notes object 852 (not shown in FIG. 8A) is added to and the Web Video object 816 is removed from the top graphical user interface of device 800 (e.g. such as when the attributes of the Notes system object and the Web Video system object are modified).

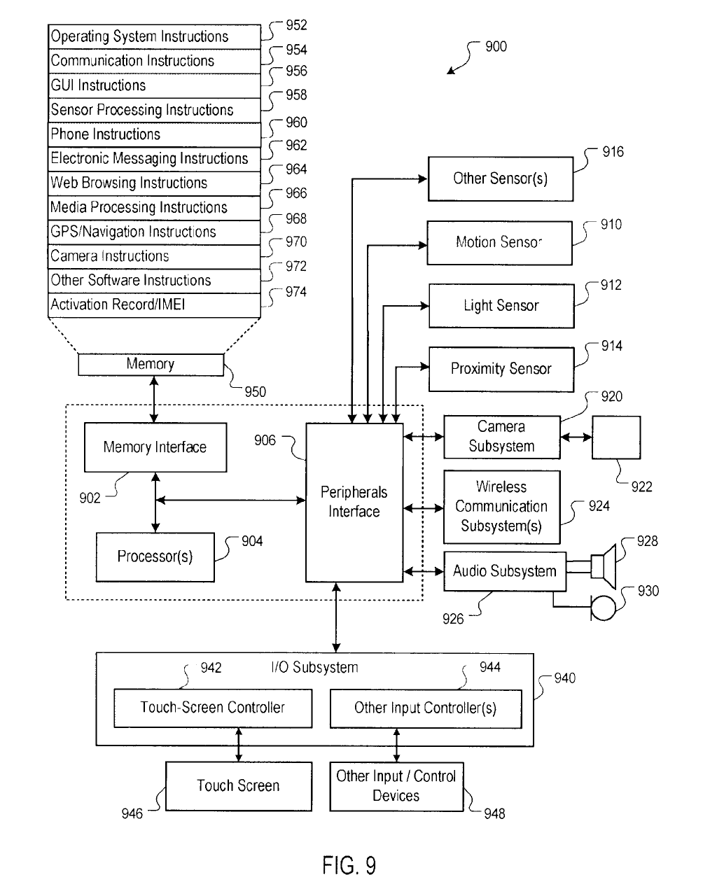

FIG. 9 is a block diagram 900 of an example implementation of a mobile device (e.g., mobile device 800). The mobile device can include a memory interface 902, one or more data processors, image processors and/or central processing units 904, and a peripherals interface 906. The memory interface 902, the one or more processors 904 and/or the peripherals interface 906 can be separate components or can be integrated in one or more integrated circuits. The various components in the mobile device can be coupled by one or more communication buses or signal lines.

Sensors, devices, and subsystems can be coupled to the peripherals interface 906 to facilitate multiple functionalities. For example, a motion sensor 910, a light sensor 912, and a proximity sensor 914 can be coupled to the peripherals interface 906 to facilitate the orientation, lighting, and proximity functions described with respect to FIG. 8A. Other sensors 916 can also be connected to the peripherals interface 906, such as a positioning system (e.g., GPS receiver), a temperature sensor, a biometric sensor, or other sensing device, to facilitate related functionalities.

A camera subsystem 920 and an optical sensor 922, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 924, which can include radio frequency receivers and transmitters and/or optical (e.g., infrared) receivers and transmitters. The specific design and implementation of the communication subsystem 924 can depend on the communication network(s) over which the mobile device is intended to operate. For example, a mobile device can include communication subsystems 924 designed to operate over a GSM network, a GPRS network, an EDGE network, a Wi-Fi or WiMax network, and a Bluetooth™ network. In particular, the wireless communication subsystems 924 may include hosting protocols such that the mobile device may be configured as a base station for other wireless devices.

An audio subsystem 926 can be coupled to a speaker 928 and a microphone 930 to facilitate voice-enabled functions, such as voice recognition, voice replication, digital recording, and telephony functions.

The I/O subsystem 940 can include a touch screen controller 942 and/or other input controller(s) 944. The touch-screen controller 942 can be coupled to a touch screen 946. The touch screen 946 and touch screen controller 942 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 946.

The other input controller(s) 944 can be coupled to other input/control devices 948, such as one or more buttons, rocker switches, thumb-wheel, infrared port, USB port, and/or a pointer device such as a stylus. The one or more buttons (not shown) can include an up/down button for volume control of the speaker 928 and/or the microphone 930.

In one implementation, a pressing of the button for a first duration may disengage a lock of the touch screen 946; and a pressing of the button for a second duration that is longer than the first duration may turn power to the mobile device on or off. The user may be able to customize a functionality of one or more of the buttons. The touch screen 946 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 902 can be coupled to memory 950. The memory 950 can include high-speed random access memory and/or non-volatile memory, such as one or more magnetic disk storage devices, one or more optical storage devices, and/or flash memory (e.g., NAND, NOR). The memory 950 can store an operating system 952, such as Darwin, RTXC, LINUX, UNIX, OS X, WINDOWS, or an embedded operating system such as VxWorks. The operating system 952 may include instructions for handling basic system services and for performing hardware dependent tasks. In some implementations, the operating system 952 can be a kernel (e.g., UNIX kernel).

The memory 950 may also store communication instructions 954 to facilitate communicating with one or more additional devices, one or more computers and/or one or more servers. The memory 950 may include graphical user interface instructions 956 to facilitate graphic user interface processing; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes and instructions; camera instructions 970 to facilitate camera-related processes and functions; and/or other software instructions 972 to facilitate other processes and functions. The memory 950 may also store other software instructions (not shown), such as web video instructions to facilitate web video-related processes and functions; and/or web shopping instructions to facilitate web shopping-related processes and functions. In some implementations, the media processing instructions 966 are divided into audio processing instructions and video processing instructions to facilitate audio processing-related processes and functions and video processing-related processes and functions, respectively. An activation record and International Mobile Equipment Identity (IMEI) 974 or similar hardware identifier can also be stored in memory 950.

All of the methods and processes described above can be embodied in, and fully automated via, software code modules executed by one or more general purpose computers. The code modules can be stored in any type of computer-readable medium or other computer storage device. Some or all of the methods can alternately be embodied in specialized computer hardware.

Although this invention has been described in terms of certain embodiments and applications, other embodiments and applications that are apparent to those of ordinary skill in the art, including embodiments which do not provide all of the features and advantages set forth herein, are also within the scope of the invention. Accordingly, the scope of the present invention is intended to be defined only by reference to the following claims.

What is claimed is:

1. A method of interacting with an application provided by a remote computing device, the method comprising:
detecting a user selection of the application on a local wireless device;
requesting service from the application via a network connection between the local wireless device and the remote computing device; and
providing the service from the application on the local wireless device through a network browser in a full-screen mode.

2. The method of claim 1 wherein providing the service from the application on the local wireless device through a network browser in a full-screen mode comprises:
providing the service by allowing interaction with the application through the network browser via the network connection; and
displaying a window for interaction with the application where the window occupies an entire display region of the local wireless device.

3. The method of claim 2 wherein providing the service by allowing interaction with the application through the network browser via the network connection comprises receiving a markup language file from the remote computing device via the network connection that includes a tag indicating the application is to be displayed in full-screen mode.

4. The method of claim 2 wherein displaying a window for interaction with the application where the window occupies an entire display region of the local wireless device comprises:
detecting, in a markup language file received from the remote computing device, a tag indicating the application is to be displayed in full-screen mode; and
displaying the window with a browser application, wherein one or more elements of the browser chrome are not displayed in full-screen mode.

5. The method of claim 1 wherein requesting service from the application via a network connection between the local wireless device and the remote computing device comprises, in response to the user selection of the application, sending a service request to the remote computing device via the network browser.

6. The method of claim 5 wherein sending the service request is performed in response to user selection of a link in an already-open browser window.

7. The method of claim 5 wherein sending the service request is performed in response to user selection of an application icon.

8. An apparatus to interact with an application provided by a remote computing device, the method comprising:
means for detecting a user selection of the application on a local wireless device;
means for requesting service from the application via a network connection between the local wireless device and the remote computing device; and
means for providing the service from the application on the local wireless device through a network browser in a full-screen mode.

9. The apparatus of claim 8 wherein means for providing the service from the application on the local wireless device through a network browser in a full-screen mode comprises:
means for providing the service by allowing interaction with the application through the network browser via the network connection; and
means for displaying a window for interaction with the application where the window occupies an entire display region of the local wireless device.

10. The apparatus of claim 9 wherein the means for providing the service by allowing interaction with the application through the network browser via the network connection comprises means for receiving a markup language file from the remote computing device via the network connection that includes a tag indicating the application is to be displayed in full-screen mode.

11. The apparatus of claim 9 wherein the means for displaying a window for interaction with the application where the window occupies an entire display region of the local wireless device comprises:
means for detecting, in a markup language file received from the remote computing device, a tag indicating the application is to be displayed in full-screen mode; and
means for displaying the window with a browser application, wherein one or more elements of the browser chrome are not displayed in full-screen mode.

12. The apparatus of claim 9 wherein means for requesting service from the application via a network connection between the local wireless device and the remote computing device comprises means for sending a service request to the remote computing device via the network browser in response to the user selection of the application.

13. An article of manufacture comprising a computer-readable medium having stored thereon instructions that when executed provide interaction with an application provided by a remote computing device, the instructions, when executed, cause one or more processors to:
detect a user selection of the application on a local wireless device;
request service from the application via a network connection between the local wireless device and the remote computing device; and
provide the service from the application on the local wireless device through a network browser in a full-screen mode.

14. The article of claim 13 wherein the instructions that cause the one or more processors to provide the service from the application on the local wireless device through a network browser in a full-screen mode further comprise instructions that, when executed, cause the one or more processors to:
provide the service by allowing interaction with the application through the network browser via the network connection; and
display a window for interaction with the application where the window occupies an entire display region of the local wireless device.

15. The article of claim 14 wherein the instructions that cause the one or more processors to provide the service by allowing interaction with the application through the network browser via the network connection comprise instructions that, when executed, cause the one or more processors to receive a markup language file from the remote computing device via the network connection that includes a tag indicating the application is to be displayed in full-screen mode.

16. The article of claim 14 wherein the instructions that cause the one or more processors to display a window for interaction with the application where the window occupies an entire display region of the local wireless device comprise instructions that, when executed, cause the one or more processors to:
detect, in a markup language file received from the remote computing device, a tag indicating the application is to be displayed in full-screen mode; and
display the window with a browser application, wherein one or more elements of the browser chrome are not displayed in full-screen mode.

17. The article of claim 13 wherein the instructions that cause the one or more processors to request service from the application via a network connection between the local wireless device and the remote computing device comprise instructions that, when executed, cause the one or more processors to send a service request to the remote computing device via the network browser in response to the user selection of the application.

18. The article of claim 17 wherein sending the service request is performed in response to user selection of a link in an already-open browser window.

19. The article of claim 17 wherein sending the service request is performed in response to user selection of an application icon.

20. A system comprising:
a display device to display a plurality of icons to a user;
a memory to store instructions and data;
a wireless network interface;
a processor coupled with the display device, the memory and the wireless network interface, the processor to generate the icons and to execute at least a portion of the instructions in response to received input, wherein, in response to selection of one of the plurality of icons, requesting service from an application corresponding to the selected icon via the wireless network interface from a remote computing device and providing the service from the application through a network browser in a full-screen mode on the display device.

21. The system of claim 20 wherein providing the service from the application on through the network browser in full-screen mode comprises the processor allowing interaction with the application through the network browser via the wireless network interface, and displaying a window for interaction with the application where the window occupies an entire display region of the display device.

22. The system of claim 21 wherein allowing interaction with the application through the network browser via the network connection comprises receiving a markup language file from the remote computing device via the network connection that includes a tag indicating the application is to be displayed in full-screen mode.

23. The system of claim 21 wherein displaying a window for interaction with the application where the window occupies an entire display region of the local wireless device comprises the processor detecting, in a markup language file received from the remote computing device, a tag indicating the application is to be displayed in full-screen mode and displaying the window with a browser application, wherein one or more elements of the browser chrome are not displayed in full-screen mode.

24. The system of claim 20 wherein requesting service from the application comprises, in response to the user selection of the application, sending a service request to the remote computing device via the network browser.

25. A method comprising:
maintaining a database to store data related to one or more network resources accessed via a network browser application on a mobile electronic device configured to communicate via a wireless network connection;
updating the database based, at least in part, on user criteria;
accessing the one or more network resources via the network browser over a wireless network if a wireless network connection is available; and
providing data related to the one or more network resources from the database to the network browser if the wireless network connection is not available.

26. The method of claim 25 further comprising:
determining whether data stored in the database is valid when the wireless network connection is available; and
updating data that is determined to be invalid.

27. The method of claim 25 wherein the one or more network resources comprise at least an application running on a remote electronic device to provide services to a user of the mobile electronic device.

28. The method of claim 25 wherein the application running on the remote device is presented to the user by the network browser application in a full-screen mode.

29. The method of claim 25 wherein the database stores a web application identifier and/or a set of cached resources associated with the web application identifier.

30. The method of claim 25, wherein the user criteria comprise one or more of monitored user behavior and/or user history.

31. An apparatus comprising:
means for maintaining a database to store data related to one or more network resources accessed via a network browser application on a mobile electronic device configured to communicate via a wireless network connection;
means for updating the database based, at least in part, on user criteria;
means for accessing the one or more network resources via the network browser over a wireless network if a wireless network connection is available; and
means for providing data related to the one or more network resources from the database to the network browser if the wireless network connection is not available.

32. The apparatus of claim 31 further comprising:
means for determining whether data stored in the database is valid when the wireless network connection is available; and
means for updating data that is determined to be invalid.

33. The apparatus of claim 31, wherein the database stores a web application identifier and/or a set of cached resources associated with the web application identifier.

34. The apparatus of claim 31, wherein the user criteria comprise one or more of monitored user behavior and/or user history.

35. An article of manufacture comprising a computer-readable medium having stored thereon instructions that, when executed, cause one or more processors to:
maintain a database to store data related to one or more network resources accessed via a network browser application on a mobile electronic device configured to communicate via a wireless network connection;
update the database based, at least in part, on user criteria;
access the one or more network resources via the network browser over a wireless network if a wireless network connection is available; and
provide data related to the one or more network resources from the database to the network browser if the wireless network connection is not available.

36. The article of claim 35 further comprising instructions that, when executed, cause the one or more processors to:
determine whether data stored in the database is valid when the wireless network connection is available; and
update data that is determined to be invalid.

37. The article of claim 35 wherein the one or more network resources comprise at least an application running on a remote electronic device to provide services to a user of the mobile electronic device.

38. The article of claim 35 wherein the application running on the remote device is presented to the user by the network browser application in a full-screen mode.

39. The article of claim 35 wherein the database stores a web application identifier and/or a set of cached resources associated with the web application identifier.

40. The article of claim 35, wherein the user criteria comprise one or more of monitored user behavior and/or user history.

41. A mobile wireless device comprising:
a wireless network interface;
a memory to store at least a database a database to store data related to one or more network resources accessed via a network browser application and the wireless network interface
a processor coupled with the wireless network interface and the memory, the processor to maintain the database and to update the database based, at least in part, on user criteria, the processor further to access the one or more network resources via the network browser and the wireless network interface if a wireless network connection is available and to provide data related to the one or more network resources from the database to the network browser if the wireless network connection is not available.

42. The mobile wireless device of claim 41, wherein the processor further determines whether data stored in the database is valid when the wireless network connection is available and updates data that is determined to be invalid.

43. The mobile wireless device of claim 41 wherein the one or more network resources comprise at least an application running on a remote electronic device to provide services to a user of the mobile wireless device.

44. The mobile wireless device of claim 41 wherein the application running on the remote device is presented by the network browser application in a full-screen mode.

45. The mobile wireless device of claim 41 wherein the database stores a web application identifier and/or a set of cached resources associated with the web application identifier.

46. The mobile wireless device of claim 41, wherein the user criteria comprise one or more of monitored user behavior and/or user history.

47. A method comprising:
generating an icon corresponding to an application on a remote computing device;
displaying the icon on a display device of a mobile wireless electronic device having a network browser and configured to connect with the remote computing device via a wireless network connection;
requesting service from the application via the wireless network connection in response to selection of the icon on the local wireless device; and
providing the service from the application on the local wireless device through a network browser.

48. The method of claim 47 wherein the network browser displays the application in a full-screen mode.

49. The method of claim 48 wherein displaying the application in full-screen mode comprises hiding components of a browser graphical user interface that are displayed when the browser is not in full-screen mode.

50. The method of claim 48 wherein displaying the application in full-screen mode comprises:
providing the service by allowing interaction with the application through the network browser via the network connection; and
displaying a window for interaction with the application where the window occupies an entire display region of the local wireless device.

51. The method of claim 47 wherein the mobile wireless electronic device provides a plurality of icons each corresponding to a different application on one or more remote computing devices.

52. The method of claim 51 wherein selection of one of the plurality of icons on the mobile wireless electronic device triggers a request for service from the corresponding application on the remote computing device to be provided via a browser on the mobile wireless electronic device to be displayed in full-screen mode.

53. An apparatus comprising:
means for generating an icon corresponding to an application on a remote computing device;
means for displaying the icon on a display device of a mobile wireless electronic device having a network browser and configured to connect with the remote computing device via a wireless network connection;
means for requesting service from the application via the wireless network connection in response to selection of the icon on the local wireless device; and
means for providing the service from the application on the local wireless device through a network browser.

54. The method of claim 53 wherein the network browser displays the application in a full-screen mode.

55. The apparatus of claim 54 wherein the means for displaying the application in full-screen mode comprises:
means for providing the service by allowing interaction with the application through the network browser via the network connection; and
means for displaying a window for interaction with the application where the window occupies an entire display region of the local wireless device.

56. The apparatus of claim 53 wherein the mobile wireless electronic device provides a plurality of icons each corresponding to a different application on one or more remote computing devices, wherein selection of one of the plurality of icons on the mobile wireless electronic device triggers a request for service from the corresponding application on the remote computing device to be provided via a browser on the mobile wireless electronic device to be displayed in full-screen mode.

57. An article of manufacture comprising a computer-readable medium having stored thereon instructions that, when executed, cause one or more processors to:
generate an icon corresponding to an application on a remote computing device;
display the icon on a display device of a mobile wireless electronic device having a network browser and configured to connect with the remote computing device via a wireless network connection;
request service from the application via the wireless network connection in response to selection of the icon on the local wireless device; and
provide the service from the application on the local wireless device through a network browser.

58. The article of claim 57 wherein the network browser displays the application in a full-screen mode.

59. The article of claim 58 wherein the instructions that cause the one or more processors to display the application in full-screen mode comprise instructions that, when executed, cause the one or more processors to hide components of a browser graphical user interface that are displayed when the browser is not in full-screen mode.

60. The article of claim 58 wherein the instructions that cause the one or more processors to display the application in full-screen mode comprise instructions that, when executed, cause the one or more processors to:
provide the service by allowing interaction with the application through the network browser via the network connection; and
display a window for interaction with the application where the window occupies an entire display region of the local wireless device.

61. The article of claim 57 wherein the mobile wireless electronic device provides a plurality of icons each corresponding to a different application on one or more remote computing devices.

62. The article of claim 61 wherein selection of one of the plurality of icons on the mobile wireless electronic device triggers a request for service from the corresponding application on the remote computing device to be provided via a browser on the mobile wireless electronic device to be displayed in full-screen mode.

63. A mobile wireless electronic device comprising:
a wireless network interface;
a processor coupled with the wireless network interface;
a memory coupled with the processor, the memory storing instructions that when executed by the processor, cause the mobile wireless electronic device to generate an icon corresponding to an application on a remote computing device, display the icon on a display device of a mobile wireless electronic device having a network browser and configured to connect with the remote computing device via a wireless network connection, request service from the application via the wireless network connection in response to selection of the icon on the local wireless device, and provide the service from the application on the local wireless device through a network browser.

64. The mobile wireless electronic device of claim 63 wherein the network browser displays the application in a full-screen mode.

65. The mobile wireless electronic device of claim 64 wherein the instructions that cause the mobile wireless electronic device to display the application in full-screen mode comprise instructions that, when executed, cause the mobile wireless electronic device to hide components of a browser graphical user interface that are displayed when the browser is not in full-screen mode.

66. The mobile wireless electronic device of claim 64 wherein the instructions that cause the mobile wireless electronic device to display the application in full-screen mode comprise instructions that, when executed, cause the mobile wireless electronic device to provide the service by allowing interaction with the application through the network browser via the network connection and display a window for interaction with the application where the window occupies an entire display region of the local wireless device.

67. A method comprising:
requesting, with a mobile wireless electronic device, service from a map application on a remote electronic device, the service to provide a map to be displayed by the mobile wireless device;
providing, with an interface on the mobile wireless electronic device, an overlay to the map, wherein the overlay includes annotations made via the mobile wireless electronic device;
displaying on the mobile wireless device, the map and the overlay contemporaneously.

68. The method of claim 67 wherein the map application is displayed via a browser on the mobile wireless electronic device in a full-screen mode.

69. The method of claim 68 wherein displaying the map application in full-screen mode comprises hiding components of a browser graphical user interface that are displayed when the browser is not in full-screen mode.

70. The method of claim 67 wherein the annotation comprises a graphical representation of a pin.

71. The method of claim 67 wherein the annotation comprises a graphical representation of a button.

72. The method of claim 67 wherein the annotation comprises an icon.

73. A method comprising:
executing, with a mobile wireless electronic device, a map application to provide a map to be displayed by the mobile wireless device;
providing, with an interface on the mobile wireless electronic device, an overlay to the map, wherein the overlay includes annotations made via the mobile wireless electronic device;
displaying on the mobile wireless device, the map and the overlay contemporaneously.

74. The method of claim 73 wherein the map application is displayed via a browser on the mobile wireless electronic device in a full-screen mode.

75. The method of claim 74 wherein displaying the map application in full-screen mode comprises hiding components of a browser graphical user interface that are displayed when the browser is not in full-screen mode.

76. The method of claim 73 wherein the annotation comprises a graphical representation of a pin.

77. The method of claim 73 wherein the annotation comprises a graphical representation of a button.

78. The method of claim 73 wherein the annotation comprises an icon.

79. An apparatus comprising:
means for requesting, with a mobile wireless electronic device, service from a map application on a remote electronic device, the service to provide a map to be displayed by the mobile wireless device;
means for providing, with an interface on the mobile wireless electronic device, an overlay to the map, wherein the overlay includes annotations made via the mobile wireless electronic device;
means for displaying on the mobile wireless device, the map and the overlay contemporaneously.

80. An apparatus comprising:
means for executing, with a mobile wireless electronic device, a map application to provide a map to be displayed by the mobile wireless device;
means for providing, with an interface on the mobile wireless electronic device, an overlay to the map, wherein the overlay includes annotations made via the mobile wireless electronic device;
means for displaying on the mobile wireless device, the map and the overlay contemporaneously.

81. An article of manufacture comprising a computer-readable medium having stored thereon instructions that, when executed, cause one or more processors to:
request, with a mobile wireless electronic device, service from a map application on a remote electronic device, the service to provide a map to be displayed by the mobile wireless device;
provide, with an interface on the mobile wireless electronic device, an overlay to the map, wherein the overlay includes annotations made via the mobile wireless electronic device;
display on the mobile wireless device, the map and the overlay contemporaneously.

82. The article of claim 81 wherein the map application is displayed via a browser on the mobile wireless electronic device in a full-screen mode.

83. The article of claim 82 wherein the instructions that cause the one or more processors to display the map application in full-screen mode further comprises instructions that, when executed, cause the one or more processors to hide components of a browser graphical user interface that are displayed when the browser is not in full-screen mode.

84. The article of claim 81 wherein the annotation comprises a graphical representation of a pin.

85. The article of claim 81 wherein the annotation comprises a graphical representation of a button.

86. The article of claim 81 wherein the annotation comprises an icon.

87. An article of manufacture comprising a computer-readable medium having stored thereon instructions that, when executed, cause one or more processors to:
execute, with a mobile wireless electronic device, a map application to provide a map to be displayed by the mobile wireless device;
provide, with an interface on the mobile wireless electronic device, an overlay to the map, wherein the overlay includes annotations made via the mobile wireless electronic device;
display on the mobile wireless device, the map and the overlay contemporaneously.

88. The article of claim 87 wherein the map application is displayed via a browser on the mobile wireless electronic device in a full-screen mode.

89. The article of claim 88 wherein displaying the map application in full-screen mode comprises hiding components of a browser graphical user interface that are displayed when the browser is not in full-screen mode.

90. The article of claim 87 wherein the annotation comprises a graphical representation of a pin.

91. The article of claim 87 wherein the annotation comprises a graphical representation of a button.

92. The article of claim 87 wherein the annotation comprises an icon.
